(19) United States
(12) Patent Application Publication
(10) Pub. No.: US 2010/0235440 A1
(43) Pub. Date: Sep. 16, 2010

(54) MESSAGE PROCESSING METHOD, SYSTEM AND CLIENT

(75) Inventor: Bin LI, Shenzhen (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Tencent Technology (Shenzhen) Company Ltd., Shenzhen (CN)

(21) Appl. No.: 12/787,604

(22) Filed: May 26, 2010

Related U.S. Application Data
(63) Continuation of application No. PCT/CN2008/073416, filed on Dec. 10, 2008.

(30) Foreign Application Priority Data
Dec. 27, 2007 (CN) 200710304431.7

(51) Int. Cl. G06F 15/16

(52) U.S. Cl. 709/203; 709/206

(57) ABSTRACT

The embodiments of the present invention disclose a message processing method including: when a backup message user selects a backup message option, obtaining a backup message and information corresponding to the backup message input by the backup message user; and sending the backup message to the target user according to the information corresponding to the backup message. The present invention also discloses a message processing system and an IM client. By using the embodiments of the present invention, a backup message function and a roaming function of the backup message can be implemented, thereby improving the availability, flexibility and convenience performance of IM software.

### FIELD OF THE INVENTION

The present invention relates to Instant Messaging (IM) technologies, and more particularly to a message processing method, system and client.

### BACKGROUND OF THE INVENTION

Along with rapid developments and wide applications of instant messaging (IM) technologies, network instant messengers have been accepted by most network users, and have gradually become an indispensable part in the daily life of users. At present, IM software not only is used in the work time of the users, but also is widely used in the leisure time of the users. Through the IM software, the user can communicate with a contact instantly and effectively.

In practical applications, the IM software may present status information of each friend through a friend list, and a user may determine whether to communicate with a certain friend according to the presented status information. In some cases, a friend whom the user wants to communicate with is not on-line, i.e. the friend is in an off-line status. In the prior art, the user may send an off-line message to the friend through an off-line message function of the IM software, and the friend may receive the off-line message instantly after logging on. However, in some cases, the user may not want to send an off-line message, but want to send a message after the friend logs on. In addition, when communicating with multiple friends simultaneously, the user may have prepared a response to a question or a topic of a certain friend and does not want to send out the response instantly, but want to wait for a proper opportunity to send out the response; or when communicating with a friend, the user bethinks of some questions to be discussed or information to be sent, but does not want to send out the questions or information instantly because the user has not considered the questions or information adequately, and thus the questions or information needs to be sent out later; hence, a more flexible message processing method is needed.

### SUMMARY OF THE INVENTION

A message processing method includes:

obtaining a backup message of a backup message user and information corresponding to the backup message, when the backup message user selects a target user and selects a backup message option; and

sending the backup message to the target user according to the information corresponding to the backup message.

A message processing system includes:

a first Instant Messaging (IM) client, adapted to obtain a backup message of a backup message user and information corresponding to the backup message when the backup message user selects a target user and selects a backup message option, and send the backup message and the information corresponding to the backup message;

an IM server, adapted to receive the backup message and the information corresponding to the backup message from the first IM client, and send the backup message and the information corresponding to the backup message to a second IM client; and

the second IM client, adapted to send the backup message to the target user according to the information corresponding to the backup message.

An IM client includes:
an information receiving and sending module, adapted to obtain a backup message and information corresponding to the backup message when a backup message user selects a target user and selects a backup message option; and a backup message managing module, adapted to send the backup message to the target user according to the information corresponding to the backup message.

An IM client includes:

an information receiving and sending module, adapted to obtain a backup message and information corresponding to the backup message from an IM server; and a backup message managing module, adapted to send the backup message to a target user according to the information corresponding to the backup message.

According to the message processing method, system and client provided by embodiments of the present invention, a backup message user may configure information which is not sent out as a backup message through a backup message option, and sends out the backup message when a target user logs on or a sending opportunity comes, so as to implement a backup message function, and further meet requirements of that the user does not want to send out information through an off-line message and want to send out the information later. Moreover, since the backup message can be directly sent to the target user when the target user logs on or the sending opportunity comes, or a prompt is automatically initiated to the backup message user, the availability and convenience performance of the IM software are improved, which provides better usage experiences for the users.

In addition, in the embodiments of the present invention, after configuring the backup message, the backup message user may log on an IM client through any computer terminal, and obtain the backup message and the information corresponding to the backup message from an IM server through the IM client, so as to implement a roaming function of the backup message, which makes the IM software more flexible, convenient and practical.

### BRIEF DESCRIPTION OF THE DRAWINGS

FIG. 1 is a schematic flowchart illustrating implementing of a backup message in accordance with an embodiment of the present invention.

FIG. 2 is a schematic flowchart illustrating roaming synchronization and an automatic prompt of a backup message in accordance with an embodiment of the present invention.

### DETAILED DESCRIPTION OF THE INVENTION

In embodiments of the present invention, a backup message user may configure information which is not sent out as a backup message by using a backup message option; when a target user logs on or a sending opportunity comes, the backup message is sent out, so as to implement a backup message function.

In addition, after configuring the backup message through an IM client, the backup message user may log on the IM client again, obtain and send out the backup message; or the backup message user may log on another IM client, and obtain the backup message from an IM server through the IM client, so as to implement a roaming function of the backup message.

The backup message user refers to a user who configures the backup message, and the target user refers to a friend whom the backup message user wants to communicate with. In the embodiments of the present invention, the IM client may be a terminal device, e.g. a personal computer.

In the embodiments of the present invention, the backup message user may configure a sending opportunity of the backup message when configuring the backup message. Correspondingly, the IM client which the backup message user logs on may check at any moment whether the sending opportunity comes, and directly send out the backup message when the sending opportunity comes; or the IM client may perform a backup message prompt, establishes a communication window corresponding to the target user according to requirement of the backup message user, and displays the contents of the backup message in the established communication window, so that the backup message user may examine or modify the backup message.

Herein, the sending opportunity refers to one of or any combination of that the target user logs on, that a configured sending time comes, that information of a designated friend is received, and that the backup message user clicks a sending button.

It is taken as an example that a backup message is configured when a friend is off-line, and a backup message function and a roaming function of the backup message in the embodiments of the present invention are described hereinafter in detail.

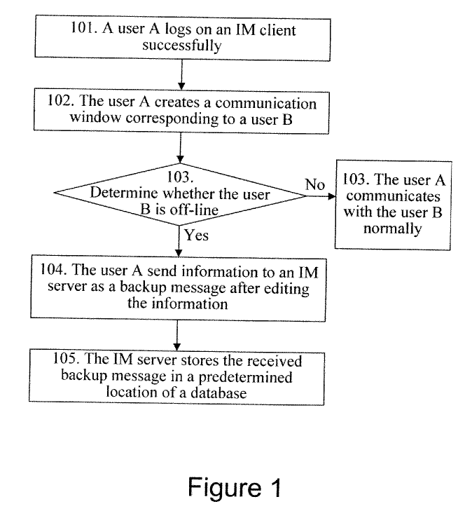

It is supposed that a user A wants to communication with a user B after logging on an IM client successfully, but the user B is off-line at present, and the user A opens a communication window corresponding to the user B in a friend list on a main panel of the IM client which the user A logs on and configures a backup message. Herein, the backup message user is the user A, and the target user is the user B. As shown in FIG. 1, the procedure of configuring a backup message includes the following steps.

Step 101: The user A inputs an account number and a password in the IM client, and sends the account number and password to an IM server through a transmission channel between the IM client and the IM server. The IM server verifies whether the account number and password are valid; if the account number and password are valid, the user A logs on the IM client successfully, and Step 102 is performed; if the account number and password are invalid, the user A fails to log on the IM client, and the procedure terminates or Step 101 is returned to, i.e. the user A inputs an account number and a password again.

Step 102: When detecting a control operation of the user A, the IM client extracts a user identifier number (UIN) of the user B designated by the user A in the control operation according to a current location of a mouse, and creates a communication window corresponding to the user B.

Herein, detecting the control operation of the user may be capturing a double-click operation of the user, or capturing a message sub-command sent through a right-key submenu. The capturing operation is usually implemented by a main panel managing module in the IM client.

The extracting operation may also be implemented by the main panel managing module in the IM client. Since each friend corresponds to a rectangle location in the main panel, a friend designated in the control operation can be determined according to the current location of the mouse. The extracting operation belongs to the prior art, and will not be further described herein. The UIN is used for identifying a user uniquely.

The communication window is created by a communication window managing module in the IM client. The creating operation belongs to the prior art, e.g. creating the communication window by using an application program interface

(API) of Windows, and will not be further described herein.

Step 103: It is determined whether the user B is off-line; if the user B is not off-line, the user A communicates with the user B normally and the procedure terminates; if the user B is off-line, the IM client creates a backup message option in the communication window.

Herein, a status managing module in the IM client obtains and determines the status of the user B. The backup message option may be configured in a shortcut toolbar in the communication window corresponding to the user B through the widget of Windows, or may be directly configured as a function button to be clicked by the user.

Step 104: When the backup message option is selected, e.g. the function button corresponding to the backup message is clicked, the IM client obtains a backup message input by the user A, i.e. a message edited by the user A, and obtains information corresponding to the backup message. The information corresponding to the backup message includes information of the user A and information of the user B, e.g. the number of the user A and the number of the user B.

After editing the message in the communication window, the user A selects the backup message option, e.g. clicks the function button corresponding to the backup message, and the IM client obtains the backup message input by the user A, i.e. the message edited by the user A, and obtains the information corresponding to the backup message. The information corresponding to the backup message includes the information of the user A and the information of the user B, e.g. the number of the user A and the number of the user B.

In order to make the backup message user be able to perform the backup message operation after the backup message user logs off, the IM client sends the backup message and the information corresponding to the backup message to the IM server, e.g. sends the backup message and the information corresponding to the backup message to the IM server through the transmission channel between the IM client and the IM server after packing the backup message and the information corresponding to the backup message into a data packet according to a protocol format and encrypting the data packet.

Herein, the backup message function is implemented by a backup message managing module in the IM client. In this step, the backup message managing module extracts the backup message, the number of the user A and the number of the user B from the communication window, packs them into the data packet, and sends the data packet to the IM server. The above information can be obtained from the communication window through a GetWindowsText function in the widget of Windows.

Step 105: After receiving the data packet, the IM server parses and decrypts the data packet, extracts the backup message, the number of the user A and the number of the user B, stores the obtained information in a predetermined location of a database, and sends a notification message of successful configuring the backup message to the IM client, and the IM client prompts the user that the backup message is configured successfully.

Herein, the predetermined location may be a storage space corresponding to the user A. In this step, the IM server queries the database by using the number of the user A, obtains the storage space corresponding to the user A, and stores the backup message, the number of the user A and the number of the user B in the storage space corresponding to the user A.

In the embodiment, after the user configures the backup message, the IM client which the user logs on monitors a sending opportunity, e.g. determines whether the target user logs on. When the sending opportunity comes, the IM client monitoring the sending opportunity may directly send out the backup message or perform a prompt operation, e.g. send a backup message prompt to the user through a created communication window, and send the backup message after the user examines and modifies the backup message.

Herein, the IM client monitoring the sending opportunity may be the IM client which the backup message user logs on when configuring the backup message. At this time, the IM client may not send the backup message and the information corresponding to the backup message to the IM server.

The IM client monitoring the sending opportunity may be another IM client which the backup message user logs on again after configuring the sending opportunity. The IM client may obtain the backup message and the information corresponding to the backup message from the IM server, so that the user A may log on the IM client through any PC terminal after configuring the backup message successfully, thereby implementing the roaming operation of the backup message.

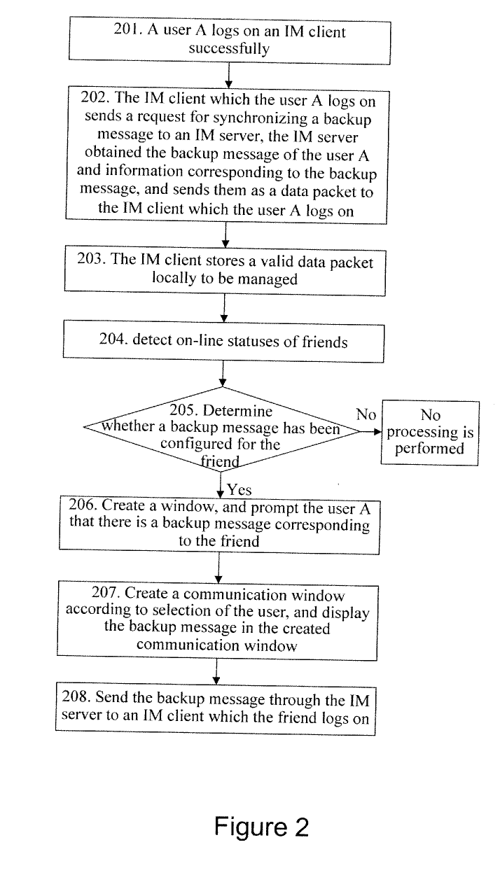

A specific procedure of the above prompt operation and roaming operation is shown in FIG. 2, and includes the following steps.

Step 201: The user A inputs an account number and a password in the IM client, and sends the account number and password to the IM server through the transmission channel between the IM client and the IM server. The IM server verifies whether the account number and password are valid; if the account number and password are valid, the user A logs on the IM client successfully, and Step 202 is performed; if the account number and password are invalid, the user A fails to log on the IM client, and the procedure terminates or Step 201 is returned to, i.e. the user A inputs an account number and a password again.

Step 202: The IM client sends a request for synchronizing a backup message to the IM server; after receiving the request, the IM server extracts the number of the user A, queries the database by using the number of the user A to obtain the backup message corresponding to the user A and the information corresponding to the backup message, packs the obtained backup message and the information corresponding to the backup message into a data packet according to a protocol format, encrypts the data packet, and sends the data packet to the IM client.

Step 203: After receiving the data packet sent by the IM server, the IM client parses and decrypts the data packet, and determines whether the data packet is a valid data packet; if the data packet is a valid data packet, extracts the backup message and the information corresponding to the backup message from the data packet, and stores the backup message and the information corresponding to the backup message locally; further, creates a relation between the target user and the backup message.

The operations in this step can be implemented by the backup message managing module, and the relation can be stored as a mapping relation table.

Step 204-205: The IM client detects on-line statuses of friends; after a certain friend logs on, the IM server issues a notification message to the IM client; the IM client extracts number information of the friend, and determines whether the user A has configured a backup message for the friend, i.e. determines whether the friend is a target user; if the friend is not the target user, the IM client does not perform processing; if the friend is the target user, Step 206 is performed.

Step 206-207: The IM client automatically creates a window to prompt the user A that there is a backup message for the friend, and asks whether to display the backup message; if the user selects not to display the backup message, the IM client directly sends the backup message to the friend. If the user selects to display the backup message, the IM client creates a communication window corresponding to the friend, and displays the contents of the backup message in a message editing area of the created communication window.

Herein, the communication window is created by the communication window managing module.

Step 208: After examining the backup message corresponding to the friend, the user A may directly send out the backup message, or modify the backup message and send out the modified backup message. The backup message is transferred through the IM server, and is sent to the IM client which the friend logs on.

The backup message transferred by the IM server may be the originally stored backup message or the backup message modified by the user A.

The procedure shown in FIG. 2 includes two portions: Steps 201-203 implements the roaming synchronization of the backup message, and Steps 204-208 implements the automatic prompt of the backup message. In practical applications, the automatic prompt in Steps 204-208 can be implemented based on that the user A implements the roaming synchronization of the backup message, and can also be implemented based on that the user A does not perform the roaming synchronization, i.e. the user A configures the backup message on a certain IM client but does not leave the IM client.

When the embodiments of the present invention are applied, a sending opportunity may be configured by the backup message user. In the embodiments of the present invention, the user may configure different sending opportunities according to requirements, or selects a sending opportunity from sending opportunities provided by the IM client. For example, the sending opportunity configured by the user may be a time period that the sending is delayed, may be that the target user logs on, or may be a triggering condition of sending. There is at least one sending opportunity configured or selected by the user. When there is more than one sending opportunity configured or selected by the user, once any sending opportunity comes, it is determined that the sending opportunity configured or selected by the user comes.

The procedure of selecting a sending opportunity by the user is described hereinafter. Since the procedure of configuring the sending opportunity by the user is similar with the procedure shown in FIGS. 1 and 2, the difference will be described hereinafter.

When the backup message user selects a sending opportunity, in Step 103, the IM client does not determine the status of the target user, but directly creates a backup message option in the created communication window.

In Step 104, when selecting the backup message option, the backup message user configures the sending opportunity, so that the user can configure the backup message when the friend is on-line or the friend is off-line. Correspondingly, the IM client sends the sending opportunity, the backup message, the number of the user A and the number of the user B to the IM server.

In Step 105, the IM server obtains and stores the sending opportunity, the backup message, the number of the user A and the number of the user B.

When the backup message user selects the sending opportunity, the backup message user may perform the roaming operation and the prompt operation of the backup message.

In Step 203, the IM client obtains the backup message and the information corresponding to the backup message, and stores the backup message and the information corresponding to the backup message locally.

In Steps 204-205, the IM client checks whether the sending opportunity comes; if the sending opportunity comes, Steps 206-208 is performed.

For example, when the backup message user communicates with multiple friends, if the backup message user does not want to instantly send out information which is prepared to send to a certain friend, the backup message user may configure the information as a backup message, and configure a sending opportunity; the sending opportunity may be a time period that the sending is delayed, e.g. configure the sending opportunity as that the sending is performed after five minutes, or configure a triggering condition, e.g. configure the triggering condition as that the backup message user clicks a sending button in the communication window corresponding to the target user or configure the triggering condition as that the backup message user receives a message of a designated user, e.g. a message of the target user or a message of a third party user. Correspondingly, when the sending opportunity comes, the IM client directly sends the backup message, or automatically sends a backup message prompt to the backup message user.

When communicating with a friend, the backup message user may also configure information which is prepared to be sent to a friend not participating in the current communication as a backup message, and then the IM client directly sends out the information or automatically sends out a backup message prompt. The friend not participating in the current communication may be an on-line friend or an off-line friend. For example, when the user A communicates with the user B and a user C, the user A want to query a user D about a thing, the user A may configure information which is prepared to be sent to the user D as a backup message, and configure a sending opportunity. When the sending opportunity comes, the IM client directly sends the backup message, or automatically sends a backup message prompt to the backup message user. The user D may be an on-line user or an off-line user.

The embodiments of present invention also provide an IM client. The IM client includes a main panel managing module, a communication window managing module, an information receiving and sending module and a backup message managing module.

The main panel managing module is adapted to determine a target user selected by a backup message user. The communication window managing module is adapted to create a communication window corresponding to the target user. The information receiving and sending module is adapted to obtain a backup message and information corresponding to the backup message input in the communication window by the backup message user when the backup message user selects a backup message option. The backup message managing module is adapted to send the backup message to the target user according to the information corresponding to the backup message.

The information receiving and sending module in the IM client is further adapted to send the backup message and the information corresponding to the backup message to an IM server.

The IM client further includes a status managing module. The status managing module is adapted to determine whether the target user is on-line; notify the communication window managing module to create the backup message option when the target user is off-line.

In the embodiments of the present invention, when the information corresponding to the backup message includes information of the backup message user and information of the target user, the backup message managing module is adapted to send the backup message to the target user according to the information of the backup message user and the information of the target user when the target user is on-line.

When the information corresponding to the backup message includes information of the backup message user, information of the target user and a sending opportunity configured by the backup message user, the backup message managing module is adapted to send the backup message to the target user according to the information of the backup message user and the information of the target user when the sending opportunity comes.

The embodiments of the present invention also provide a message processing system, including an IM server, a first IM client and a second IM client.

The first IM client is adapted to create a communication window corresponding to a target user after a backup message user selects the target user, create a backup message option in the communication window, obtain a backup message and information corresponding to the backup message input in the communication window by the backup message user after the backup message user selects the backup message option, and send out the backup message and the information corresponding to the backup message.

The IM server is adapted to receive the backup message and the information corresponding to the backup message from the first IM client, and send the backup message and the information corresponding to the backup message to the second IM client.

The second IM client is adapted to send the backup message to the target user according to the information corresponding to the backup message.

In addition, the second IM client is further adapted to send a request for synchronizing a backup message to the IM server; correspondingly, the IM server is adapted to send the backup message and the information corresponding to the backup message to the second IM client according to the request from the second IM client. The second IM client is further adapted to store the backup message and the information corresponding to the backup message.

In the embodiments of the present invention, the IM server stores the backup message and the information corresponding to the backup message obtained by the first IM client, and the second IM client sends the backup message to the target user according to the information corresponding to the backup message, so as to implement the roaming function of the backup message.

Specifically, the second IM client includes an information receiving and sending module and a backup message managing module.

The information receiving and sending module is adapted to obtain from the IM server the backup message and the information corresponding to the backup message input by the backup message user. The backup message managing module is adapted to send the backup message to the target user according to the information corresponding to the backup message.

In addition, the backup message managing module in the second IM client is further adapted to send a request for synchronizing a backup message, receive the backup message and the information corresponding to the backup message from the information receiving and sending module, and store the backup message and the information corresponding to the backup message.

When the information corresponding to the backup message includes information of the backup message user and information of the target user, the backup message managing module in the second IM client is adapted to send the backup message to the target user according to the information of the backup message user and the information of the target user when the target user is on-line.

When the information corresponding to the backup message includes the information of the backup message user, the information of the target user and a sending opportunity configured by the backup message user, the backup message managing module in the second IM client is adapted to send the backup message to the target user according to the information of the backup message user and the information of the target user when the sending opportunity comes.

The foregoing is merely preferable embodiments of the present invention, but not used to limit the protection scope of the present invention. In specific implementations, the preferable embodiments of the present invention can be modified properly to adapt to the requirements of practical situations. Therefore, it should be understood that the embodiments of the present invention described herein are only examples and not used to limit the protection scope of the present invention.

1. A message processing method, comprising:
obtaining a backup message of a backup message user and information corresponding to the backup message, when the backup message user selects a target user and selects a backup message option; and
sending the backup message to the target user according to the information corresponding to the backup message.

2. The message processing method of claim 1, further comprising:
creating a communication window corresponding to the target user after the backup message user selects the target user, the backup message being input in the communication window; and
creating the backup message option in the communication window.

3. The message processing method of claim 1, wherein the backup message and the information corresponding to the backup message are obtained by a first Instant Messaging (IM) client after the backup message user logs on the first IM client.

4. The message processing method of claim 3, wherein the backup message is sent to the target user by the first IM client.

5. The message processing method of claim 3, further comprising:
sending, by the first IM client, the backup message and the information corresponding to the backup message to an IM server.

6. The message processing method of claim 5, further comprising:
sending, by the IM server, a notification message of successfully configuring the backup message to the first IM client.

7. The message processing method of claim 5, wherein the backup message is sent to the target user by a second IM client after the backup user logs on the second IM client, and the first IM client and the second IM client are different;
the method further comprises:
obtaining, by the second IM client, the backup message and the information corresponding to the backup message from the IM server.

8. The message processing method of claim 7, wherein obtaining, by the second IM client, the backup message and the information corresponding to the backup message from the IM server comprises:
sending, by the second IM client, a request for synchronizing a backup message to the IM server; and
receiving the backup message and the information corresponding to the backup message sent by the IM server.

9. The message processing method of claim 7, further comprising:
storing, by the second IM client, the backup message and the information corresponding to the backup message.

10. The message processing method of claim 2, wherein creating the backup message option in the communication window comprises:
determining whether the target user is off-line, and creating the backup message option when the target user is off-line;
the information corresponding to the backup message comprises:
information of the backup message user and information of the target user;
sending the backup message to the target user according to the information corresponding to the backup message comprises:
sending the backup message to the target user according to the information of the backup message user and the information of the target user when the target user logs on.

11. The message processing method of claim 1, wherein the information corresponding to the backup message comprises:
information of the backup message user, information of the target user and a sending opportunity configured by the backup message user;
sending the backup message to the target user according to the information corresponding to the backup message comprises:
sending the backup message to the target user according to the information of the backup message user and the information of the target user when the sending opportunity comes.

12. The message processing method of claim 11, wherein sending the backup message to the target user comprises:
sending the backup message to the target user directly; or
prompting the backup message user to examine the backup message; when the backup message user needs to examine the backup message, creating a communication window corresponding to the target user, displaying the backup message in the communication window created, and sending the backup message to the target user after the backup message user confirms the backup message.

13. The message processing method of claim 12, wherein sending the backup message to the target user after the user confirms the backup message, comprises:
obtaining the backup message modified by the backup message user, and sending the backup message modified to the target user.

14. The message processing method of claim 11, wherein the sending opportunity comprises at least one of that the target user logs on, that configured sending time comes, that information of a designated friend is received, and that the backup message user clicks a sending button.

15. A message processing system, comprises:
a first Instant Messaging (IM) client, adapted to obtain a backup message of a backup message user and information corresponding to the backup message when the backup message user selects a target user and selects a backup message option, and send the backup message and the information corresponding to the backup message;
an IM server, adapted to receive the backup message and the information corresponding to the backup message from the first IM client, and send the backup message and the information corresponding to the backup message to a second IM client; and
the second IM client, adapted to send the backup message to the target user according to the information corresponding to the backup message.

16. The message processing system of claim 15, wherein the first IM client is further adapted to create a communication window corresponding to the target user after the backup message user selects the target user, and create the backup message option in the communication window, the backup message being input in the communication window.

17. The message processing system of claim 15, wherein
the second IM client is further adapted to send a request for synchronizing a backup message to the IM server; and
the IM server is adapted to send the backup message and the information corresponding to the backup message to the second IM client according to the request from the second IM client.

18. The message processing system of claim 15, wherein the second IM client is further adapted to store the backup message and the information corresponding to the backup message.

19. An Instant Messaging (IM) client, comprising:
an information receiving and sending module, adapted to obtain a backup message and information corresponding to the backup message when a backup message user selects a target user and selects a backup message option; and
a backup message managing module, adapted to send the backup message to the target user according to the information corresponding to the backup message.

20. The IM client of claim 19, further comprising:
a main panel managing module, adapted to determine the target user selected by the backup message user; and
a communication window managing module, adapted to create a communication window corresponding to the target user, the backup message being input in the communication window.

21. The IM client of claim 19, wherein the information receiving and sending module is further adapted to send the backup message and the information corresponding to the backup message to an IM server.

22. The IM client of claim 20, further comprising:
a status managing module, adapted to determine whether the target user is off-line, and notify the communication window managing module to create the backup message option when the target user is off-line.

23. The IM client of claim 22, wherein the information corresponding to the backup message comprises: information of the backup message user and information of the target user; and
the backup message managing module is adapted to send the backup message to the target user according to the information of the backup message user and the information of the target user when the target user logs on.

24. The IM client of claim 19, wherein the information corresponding to the backup message comprises: information of the backup message user, information of the target user and a sending opportunity configured by the backup message user; and
the backup message managing module is adapted to send the backup message to the target user according to the information of the backup message user and the information of the target user when the sending opportunity comes.

25. An Instant Messaging (IM) client, comprising:
an information receiving and sending module, adapted to obtain a backup message and information corresponding to the backup message from an IM server; and
a backup message managing module, adapted to send the backup message to a target user according to the information corresponding to the backup message.

26. The IM client of claim 25, wherein the backup message managing module is further adapted to send a request for synchronizing a backup message to the IM server, and receive the backup message and the information corresponding to the backup message from the information receiving and sending module.

27. The IM client of claim 25, wherein the backup message managing module is further adapted to store the backup message and the information corresponding to the backup message.

28. The IM client of claim 25, wherein the information corresponding to the backup message comprises: information of the backup message user and information of the target user; and
the backup message managing module is adapted to send the backup message to the target user according to the information of the backup message user and the information of the target user when the target user logs on.

29. The IM client of claim 25, wherein the information corresponding to the backup message comprises: information of the backup message user, information of the target user and a sending opportunity configured by the backup message user; and
the backup message managing module is adapted to send the backup message to the target user according to the information of the backup message user and the information of the target user when the sending opportunity comes.
